(19) United States
(12) Patent Application Publication
(10) Pub. No.: US 2015/0163862 A1
(43) Pub. Date: Jun. 11, 2015

(54) POLYMER THICK FILM DEVICE

(71) Applicant: IEE INTERNATIONAL ELECTRONICS & ENGINEERING S.A., Echternach (LU)

(72) Inventors: Driss Chabach, Noertrange (LU); Raphael Bennes, Haute Kontz (FR); Alain Schumacher, Igel (DE)

(21) Appl. No.: 14/403,165

(22) PCT Filed: May 22, 2013
(86) PCT No.: PCT/EP2013/060527

§ 371 Date: Nov. 22, 2014

(30) Foreign Application Priority Data
May 23, 2012 (LU) 92007

(51) Int. Cl. H05B 3/14; H05B 3/34

(52) U.S. Cl. CPC H05B 3/145; H05B 3/345; H05B 3/347

(57) ABSTRACT

A PTF (polymer thick film) device (10) comprises a substrate (22, 32), a functional PTF layer (24,34) applied on the substrate and a protective cover (25, 35) applied over the PTF layer, the protective cover being an adhesive tape comprising a carrier layer (27, 37) and a layer of adhesive (26, 36), the carrier layer being coated with the layer of adhesive (26, 36), the layer of adhesive (26,36) having a thickness comprised in the range from 10% to 100% of the print thickness of the PTF layer (24, 34). The PTF layer is a carbon ink layer, a silver ink layer, a graphite ink layer, a carbon-silver ink layer, a carbon-graphite ink layer, a graphite-silver ink layer, a carbon-graphite-silver ink layer or a PTC layer (Positive Temperature Coefficient). The PTF device can be used as an electric heater, e.g for car seats.

### TECHNICAL FIELD

The present invention generally relates to electrically conductive PTF (polymer thick film) layers, in particular to enhancement of temperature and lifetime stability of such layers.

### BACKGROUND ART

As a matter of fact, all kinds of polymer-based electrical circuits, including sensors, heater systems, human-machine interfaces (HMIs) depending on the used material types and designs react more or less sensitive in terms of their electrical resistances to temperature impact generated e.g. during storage, transportation and/or application.

For instance, electronic polymer circuits deposited onto a polymer film or assembled in a sandwich of polymer film(s) and/or adhesive films/layers, tend to suffer from variation of their electrical resistance due to temperature-induced relaxation processes and mechanical interactions between the different material components, e.g. interactions between the functional layer and laminated adhesive layer and/or substrate, textile fabric, none-woven, etc.

However, temperature stability with regard to a specified functionality over lifetime in the range from −40° C. to 110° C. with and without additional imposed climatic stress up to 100% of relative humidity, are standard specification requirements for e.g. any kind of sensor/heater in an automotive application or for HMI input devices in general. Depending on the application/functionality, temperature impacts can be compensated via hardware via, software, design and/or post processing. Although these approaches represent common straightforward and very useful remedies for certain applications, there are less suitable in applications where high reproducibility and repeatability of electrical functionality characteristics over lifetime are needed, where design freedom is reduced, or where these approaches are simply too expensive.

Especially in the case of PTF based PTC (Positive Temperature Coefficient) heater devices, mechanical interaction between the different components/layers of the heater sandwich has a tremendous impact on the temperature and lifetime stability of its electrical resistances and the PTC effect. This can be explained on a phenomenological base by the fact that the pronounced, generally strongly non-linear increase of electrical resistance with increasing temperature is accompanied by a volume change of the PTF resin(s).

In almost all types of electrical devices (e.g. heater and/or sensor system) the application of a cover layer, laminated, ironed or printed on top of the PTF layer is mandatory in order to protect against environmental influences like humidity, noxious gases, mechanical or electrochemical degradation, etc. At present, the lamination of a double-sided adhesive film onto the substrate with the PTF layer, in combination with any kind of textile layer represents a robust protection solution over lifetime with regard to the mentioned requirements and is at the same time a very cost-efficient process step. Due to the material properties of PTF electrical layers—in particular for those with PTC functionality—and the tape materials, long-term mechanical relaxation processes lead to creep/drift effects each time the system is exposed to higher temperatures. These relaxation processes go on till the complete system reaches the steady state of mechanical stress equilibrium. Early stabilization can be significantly enhanced by interim thermal storage of semi-finished parts (e.g. substrate with PTC layer with or without laminated tape layer), hot lamination and/or thermal storage after complete assembly of the electrical device. In some cases even a so-called run-in process—operating of the system for a given time—may become necessary. All these stabilization processes are time consuming (last in general several hours) and cost-intensive on production level in terms of logistics, equipment, etc.

However, for the time being these unprepossessing efforts for stabilization have to be accepted, since otherwise the product risks to continuously lose performance over lifetime (e.g. loss of heating power due to increased resistance in case of a PTC layer) and consequently fail to meet performance requirements.

### BRIEF SUMMARY

It is proposed to reduce the impact on the electrical resistance of PTF layers by an appropriate configuration of the protective adhesive layer.

According to an aspect of the invention, a PTF (polymer thick film) device comprises a substrate, a functional PTF layer applied (printed, e.g. screen-printed) on the substrate and a protective cover applied (e.g. by laminating) over the PTF layer. The protective cover comprises a layer of adhesive, the thickness of which is comprised in the range from 10% to 100%, preferably from 10% to 30%, of the print thickness of the PTF layer. The protective cover is an adhesive tape that comprises a carrier layer coated with the layer of adhesive.

The carrier layer preferably has a thickness of 12 μm at most. Preferably, the layer of adhesive has a thickness of 12 μm at most. More preferably, the thickness of the carrier layer is comprised in the range from 3 to 10 μm and the thickness of the layer of adhesive is comprised in the range from 3 to 10 μm. Even more preferably, the thickness of the carrier layer is comprised in the range from 3 to 7 μm and the thickness of the layer of adhesive is comprised in the range from 3 to 7 μm. Most preferably, the thickness of the carrier layer amounts to 5 μm and the thickness of the layer of adhesive amounts to 5 μm. As regards the substrate, its thickness is preferably comprised between 50 μm and 500 μm.

It is the inventors' merit to have recognized that much more stable electrical properties (especially in terms of electrical resistance) of the PTF layer can be reached if the thickness of the layer of adhesive is comprised in the indicated range. As shall be appreciated, the thickness of the layer of adhesive is considerably reduced in comparison with prior art PTF devices. The chosen configuration considerably reduces penetration of the PTF layer by the applied adhesive and vice versa. Consequently, mechanical stress caused by such interpenetration in combination with environmental influences like temperature changes or humidity changes is significantly reduced between the electrically conductive PTF layer and the other layers of the layered structure.

The protective cover may also be a double-sided adhesive tape that comprises a carrier layer having a first side coated with the layer of adhesive and a second side coated with a further layer of adhesive. Also in this case, the carrier layer and the adhesive layer preferably have each a thickness of 12 μm at most. The further layer of adhesive preferably comprises at most 300 g/m² of adhesive.

Preferably, the substrate or the carrier layer comprises at least one of PUR (polyurethane), PET (polyethylene terephthalate), PEN (polyethylene naphthalate), PEI (polyether imide), PE (polyethylene), ABS (acrylonitrile butadiene styrene), PES (polyether sulfone), PS (polystyrene), PEEK (polyether ether ketone), PI (polyimide), PP (polypropylene), non-woven textile, woven textile and knitted textile.

The layer of adhesive and/or the further layer of adhesive preferably comprises at least one of acrylic, modified acrylic, hotmelt, rubber-based adhesive and silicone.

The PTF layer may be a PTC (positive temperature coefficient) layer. A PTC material is a material the specific electric resistance of which rises with increasing temperature. The temperature coefficient indicates the increase in resistance per unit of temperature increase. A heating element having such a PTC characteristic self-regulates the heat that it emits. As an electrical current is caused to flow across the heating element, the temperature of the heating element rises. Due to the increasing resistance, the electrical current is reduced until equilibrium is reached.

A further preferred aspect of the invention concerns an electric heater that comprises a heating element arranged as a PTF device as described hereinabove.

It is worthwhile noting that, if the PTF layer is patterned, such that the adhesive layer is directly in contact not only with the PTF layer but also, locally, with the underlying substrate, the protective cover will conform itself to some extent to the pattern, leading to local unevenness of the protective cover. It follows that any patterning of the PTF layer does not result in a significant variation of the thickness of the adhesive layer. Accordingly, the thickness of the adhesive layer is well-defined even in the presence of a patterned PTF layer.

It shall also be noted that, further to the PTF layer, layers applied by other technologies (e.g. galvanic deposition, PVD, sputtering, evaporation, etc.) may be present on the substrate. For instance, the substrate could carry the PTF layer as well as one or more connection lines (so-called bus bars) for electrically connecting the PTF layer to an electrical circuit. The connection lines could be made of any highly conductive material, e.g. Cu, Ag, Ni, Cu/Ag, etc. deposited galvanically or by PVD, etc. Nevertheless, such connection lines could also be realized as a PTF layer (e.g. made from PTF silver ink, PTF copper ink, PTF copper/silver ink, etc.)

### BRIEF DESCRIPTION OF THE DRAWINGS

Further details and advantages of the present invention will be apparent from the following detailed description of several not limiting embodiments with reference to the attached drawings, wherein:

FIG. 1 is a schematic cross sectional view of a PTF device according to a first preferred embodiment of the invention;

FIG. 2 is a schematic cross sectional view of a PTF device according to a second preferred embodiment of the invention;

FIG. 3 is a schematic cross sectional view of a PTF device according to a third preferred embodiment of the invention.

### DESCRIPTION OF PREFERRED EMBODIMENTS

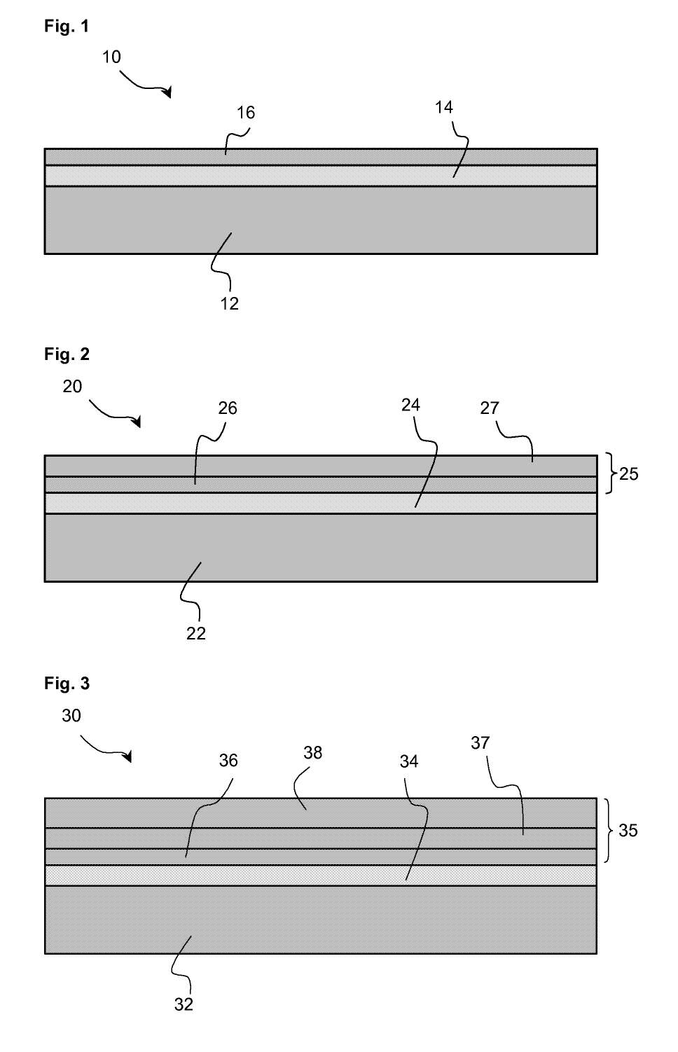

FIG. 1 schematically illustrates a PTF device 10 according to a preferred embodiment of the invention. PTF device 10 comprises a substrate 12, made e.g. of PUR, PET, PEN, PEI, PE, ABS, PES, PS, PEEK, PI, PP, non-woven textile, woven textile or knitted textile.

The substrate 12 carries a PTF print 14 having a print thickness preferably comprised in the range from 4 μm to 25 μm. The PTF layer 14 may e.g. be a carbon ink layer, a silver ink layer, a graphite ink layer, a carbon-silver ink layer, a carbon-graphite ink layer, a graphite-silver ink layer or a carbon-graphite-silver ink layer. Depending on the application, the PTF layer 14 may have a positive temperature coefficient (i.e. exhibit increasing electrical resistance with increasing temperature).

A layer of adhesive 16 (preferably selected among acrylic, modified acrylic, hotmelt, rubber-based adhesive and silicone) is applied over the PTF layer 14. The thickness of the layer of adhesive (transfer tape) is comprised between 10% and 100%, more preferably between 10% and 30%) of the thickness of PTF layer 14.

FIG. 2 schematically illustrates a PTF device 20 according to a second preferred embodiment of the invention. PTF device 20 comprises a substrate 22, made e.g. of PUR, PET, PEN, PEI, PE, ABS, PES, PS, PEEK, PI, PP, non-woven textile, woven textile or knitted textile.

The substrate 22 carries a PTF print 24 having a print thickness preferably comprised in the range from 4 μm to 25 μm. The PTF layer 24 may e.g. be a carbon ink layer, a silver ink layer, a graphite ink layer, a carbon-silver ink layer, a carbon-graphite ink layer, a graphite-silver ink layer or a carbon-graphite-silver ink layer. Depending on the application, the PTF layer 24 may have a positive temperature coefficient.

A single-sided adhesive tape 25 is arranged over the PTF layer 24. The adhesive tape 25 comprises a carrier film or sheet 27 (made e.g. of PUR, PET, PEN, PEI, PE, ABS, PES, PS, PEEK, PI, PP, non-woven textile, woven textile or knitted textile) that carries a layer of adhesive 26 (preferably selected among acrylic, modified acrylic, hotmelt, rubber-based adhesive and silicone), which is in contact with the PTF layer 24 (and, in case of gaps in the PTF layer 24, with the substrate 22). The thickness of the layer of adhesive 26 is comprised between 10% and 100%, more preferably between 10% and 30%, of the thickness of PTF layer 24. The thickness of the carrier film or sheet 27 is chosen below or equal to 10μm.

FIG. 3 schematically illustrates a PTF device 30 according to a third preferred embodiment of the invention. PTF device 30 comprises a substrate 32, made e.g. of PUR, PET, PEN, PEI, PE, ABS, PES, PS, PEEK, PI, PP, non-woven textile, woven textile or knitted textile.

The substrate 32 carries a PTF print 34 having a print thickness preferably comprised in the range from 4 μm to 25 μm. The PTF layer 34 may e.g. be a carbon ink layer, a silver ink layer, a graphite ink layer, a carbon-silver ink layer, a carbon-graphite ink layer, a graphite-silver ink layer or a carbon-graphite-silver ink layer. Depending on the application, the PTF layer 34 may have a positive temperature coefficient.

A double-sided adhesive tape 35 is arranged over the PTF layer 34. The adhesive tape 35 comprises a carrier film or sheet 37 (made e.g. of PUR, PET, PEN, PEI, PE, ABS, PES, PS, PEEK, PI, PP, non-woven textile, woven textile or knitted textile) that carries, on its first side, a first layer of adhesive 36 which is in contact with the PTF layer 34 (and, in case of gaps in the PTF layer 34, with the substrate 32) and, on its second side, a second layer of adhesive 38. Both adhesives 36, 38 are preferably selected among acrylic, modified acrylic, hotmelt, rubber-based adhesive and silicone. The adhesives 36, 38 may be made of the same material or of different materials. The thickness of the first layer of adhesive 36 is comprised between 10% and 100% (more preferably between 10% and 30%) of the thickness of PTF layer 34. The amount of adhesive on the second side of the carrier film or sheet 37 is preferably less than 300 g/m². The thickness of the carrier film or sheet 37 is chosen below or equal to 10 μm.

As will be appreciated, the layer construction in accordance with the invention enhances the stability of the PTF layer without impacting its performance over lifetime. The invention is especially useful if the PTF device is used as the (ohmic) heating element of a heater, e.g. a seat heater.

While specific embodiments have been described in detail, those skilled in the art will appreciate that various modifications and alternatives to those details could be developed in light of the overall teachings of the disclosure. Accordingly, the particular arrangements disclosed are meant to be illustrative only and not limiting as to the scope of the invention, which is to be given the full breadth of the appended claims and any and all equivalents thereof.

1. PTF device, comprising:
a substrate;
a functional PTF layer applied on said substrate, said PTF layer having a print thickness;
a protective cover applied over said PTF layer, said protective cover being an adhesive tape comprising a carrier layer and a layer of adhesive, said carrier layer being coated with said layer of adhesive, said layer of adhesive having a thickness comprised in the range from 10% to 100% of the print thickness of said PTF layer.

2. PTF device as claimed in claim 1, wherein said layer of adhesive has a thickness comprised in the range from 10% to 30% of the print thickness of said PTF layer.

3. PTF device as claimed in claim 1, wherein said substrate comprises at least one of PUR, PET, PEN, PEI, PE, ABS, PES, PS, PEEK, PI, PP, non-woven textile, woven textile and knitted textile.

4. PTF device as claimed in claim 1, wherein said layer of adhesive comprises at least one of acrylic, modified acrylic, hotmelt, rubber-based adhesive and silicone.

5. PTF device as claimed in claim 1, wherein said carrier layer has a thickness of 12 μm at most.

6. PTF device as claimed in claim 5, wherein said layer of adhesive has a thickness comprised in the range from 3 to 12 μm.

7. PTF device as claimed in claim 1, wherein said carrier layer has a thickness of 10 μm at most.

8. PTF device as claimed in claim 1, wherein said adhesive tape is a double-sided adhesive tape having a first side of said carrier layer coated with said layer of adhesive and a second side of said carrier layer coated with a further layer of adhesive, said carrier layer having a thickness of 10 μm at most.

9. PTF device as claimed in claim 7, wherein said layer of adhesive has a thickness comprised in the range from 3 to 10 μm.

10. PTF device as claimed in claim 8, wherein said further layer of adhesive comprises at most 300 g/m² of adhesive.

11. PTF device as claimed in claim 8, wherein said further layer of adhesive comprises at least one of acrylic, modified acrylic, hotmelt, rubber-based adhesive and silicone.

12. PTF device as claimed in claim 8, wherein said carrier layer comprises at least one of PET, PEN, PEI, PE, ABS, PES, PS, PEEK, PI, PP, non-woven textile, woven textile and knitted textile.

13. PTF device as claimed in claim 1, wherein said PTF layer is a carbon ink layer, a silver ink layer, a graphite ink layer, a carbon-silver ink layer, a carbon-graphite ink layer, a graphite-silver ink layer or a carbon-graphite-silver ink layer.

14. PTF device as claimed in claim 1, wherein said PTF layer is a PTC layer.

15. Electric heater comprising a heating element arranged as a PTF device as claimed in claim 14.

16. PTF device, comprising:
a substrate;
a functional PTF layer applied on said substrate, said PTF layer having a print thickness;
a protective cover applied over said PTF layer, said protective cover being an adhesive tape comprising a carrier layer and a layer of adhesive, said carrier layer being coated with said layer of adhesive, said layer of adhesive having a thickness comprised in the range from 3 to 12 μm.

17. PTF device as claimed in claim 16, wherein said layer of adhesive has a thickness comprised in the range from 10% to 100% of the print thickness of said PTF layer.

18. PTF device as claimed in claim 16, wherein said layer of adhesive has a thickness comprised in the range from 10% to 30% of the print thickness of said PTF layer.

19. PTF device as claimed in claim 16, wherein said substrate comprises at least one of PUR, PET, PEN, PEI, PE, ABS, PES, PS, PEEK, PI, PP, non-woven textile, woven textile and knitted textile.

20. PTF device as claimed in claim 16, wherein said layer of adhesive comprises at least one of acrylic, modified acrylic, hotmelt, rubber-based adhesive and silicone.

21. PTF device as claimed in claim 16, wherein said carrier layer has a thickness of 12 μm at most.

22. PTF device as claimed in claim 16, wherein said carrier layer has a thickness of 10 μm at most.

23. PTF device as claimed in claim 16, wherein said adhesive tape is a double-sided adhesive tape having a first side of said carrier layer coated with said layer of adhesive and a second side of said carrier layer coated with a further layer of adhesive, said carrier layer having a thickness of 10 μm at most.

24. PTF device as claimed in claim 23, wherein said layer of adhesive has a thickness comprised in the range from 3 to 10 μm.

25. PTF device as claimed in claim 23, wherein said further layer of adhesive comprises at most 300 g/m² of adhesive.

26. PTF device as claimed in claim 23, wherein said further layer of adhesive comprises at least one of acrylic, modified acrylic, hotmelt, rubber-based adhesive and silicone.

27. PTF device as claimed in claim 23, wherein said carrier layer comprises at least one of PET, PEN, PEI, PE, ABS, PES, PS, PEEK, PI, PP, non-woven textile, woven textile and knitted textile.

28. PTF device as claimed in claim 16, wherein said PTF layer is a carbon ink layer, a silver ink layer, a graphite ink layer, a carbon-silver ink layer, a carbon-graphite ink layer, a graphite-silver ink layer or a carbon-graphite-silver ink layer.

29. PTF device as claimed in claim 16, wherein said PTF layer is a PTC layer.

30. Electric heater comprising a heating element arranged as a PTF device as claimed in claim 29.
